(19) United States
(12) Patent Application Publication
(10) Pub. No.: US 2006/0146932 A1
(43) Pub. Date: Jul. 6, 2006

(54) Method and apparatus for providing motion estimation with weight prediction

(76) Inventors: Krit Panusopone, San Diego, CA (US); Xue Fang, San Diego, CA (US); Limin Wang, San Diego, CA (US)

Correspondence Address: PATTERSON & SHERIDAN L.L.P., 595 SHREWSBURY AVE, STE 100, FIRST FLOOR, SHREWSBURY, NJ, 07702, US

(21) Appl. No.: 11/026,404

(22) Filed: Dec. 30, 2004

(51) Int. Cl. H04N 7/12; H04N 11/04; H04B 1/66; H04N 11/02

(52) U.S. Cl. 375/240.12; 375/240.24

(57) ABSTRACT

The present invention discloses an apparatus and method for providing a motion estimation method with weight prediction that requires less memory and computation cycles. In one embodiment, the weight is applied to pixels of a current slice or picture instead of the reference picture. In doing so, the number of processing cycles is significantly reduced while retaining the benefits of implementing a motion estimation method with weight prediction.

### BACKGROUND OF THE INVENTION

1. Field of the Invention

Embodiments of the present invention generally relate to an encoding system. More specifically, the present invention relates to a motion estimation method with weight prediction.

2. Description of the Related Art

Weighted sample prediction process has been adopted in the new ITU-T H.264/MPEG4 AVC video coding standard, herein referred to as AVC. Weight prediction offers a significant coding gain for fading video scene encoding. Fading is commonly used in television production studio to switch from one video program to another. Assume a cross fading from video program A to video program B. The output of this cross fading impact is typically controlled by a linear equation as follows:
output=α×A+(1−α)×B, where 0≦α≦1.

AVC allows three types of slices or pictures, i.e., I, P and B. Among the three slices or pictures, P and B are temporally predictive coded, where the temporal references are previously coded pictures. One of the core functions in temporal prediction coding is motion estimation and compensation. In block-based motion estimation and compensation, for a given block in the current picture, motion estimation process determines a temporal prediction block, which can be one block, or an average of two blocks, from the reference pictures. The determined blocks are often motion compensated by so-called motion vectors at sub-pel resolution. The difference between the given block and its temporal prediction is called motion compensated prediction errors. The motion compensated errors are encoded, generating the compressed bitstream.

Traditional temporal prediction process does not take the fading impact into consideration. In other words, all the reference pictures are treated equally in motion estimation and compensation process. Weight prediction process in AVC however exploits the fading characteristic by further weighting the sample pixels of the reference pictures. The weighted reference pictures more closely imitate the fading effect. It has been demonstrated by experimental results that the weight prediction process is more efficient than the traditional un-weight prediction process in terms of addressing the fading scenario. Unfortunately, although weight prediction provides advantages in dealing with the fading scenario, it is computationally expensive and/or requires a substantial amount of memory resources.

Thus, there is a need in the art for a motion estimation method with weight prediction that requires less memory and computation cycles.

### SUMMARY OF THE INVENTION

In one embodiment, the present invention discloses an apparatus and method for providing a motion estimation method with weight prediction that requires less memory and computation cycles. In one embodiment, the weight is applied to at least one pixel of a current block of a current slice or picture instead of the reference picture. In doing so, the number of processing cycles is significantly reduced while retaining the benefits of implementing a motion estimation method with weight prediction.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a motion compensated encoder of the present invention;

FIG. 2 illustrates a method for performing motion estimation with weight prediction of the present invention; and

FIG. 3 illustrates the present invention implemented using a general purpose computer.

To facilitate understanding, identical reference numerals have been used, wherever possible, to designate identical elements that are common to the figures.

### DETAILED DESCRIPTION OF THE PREFERRED EMBODIMENT

It should be noted that although the present invention is described within the context of H.264/MPEG4 AVC, the present invention is not so limited. Namely, the present motion compensated encoder can be an H.264/MPEG-4 AVC compliant encoder or an encoder that is compliant to any other compression standards that are capable of exploiting the present motion estimation scheme.

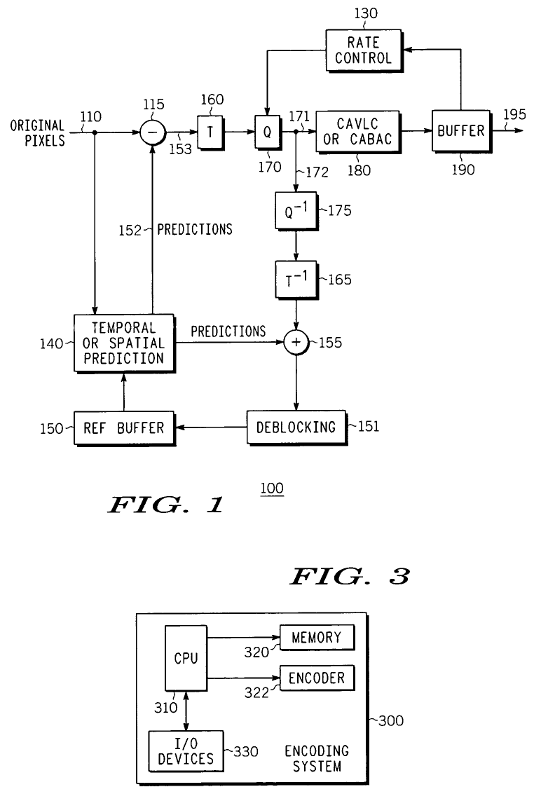

FIG. 1 depicts a block diagram of an exemplary motion compensated encoder 100 of the present invention. In one embodiment of the present invention, the apparatus 100 is an encoder or a portion of a more complex motion compensation coding system. The apparatus 100 comprises a temporal or spatial prediction module 140 (e.g., comprising a variable block motion estimation module and a motion compensation module), a rate control module 130, a transform module 160, e.g., a discrete cosine transform (DCT) based module, a quantization (Q) module 170, a context adaptive variable length coding (CAVLC) module or context-adaptive binary arithmetic coding module (CABAC) 180, a buffer (BUF) 190, an inverse quantization (Q⁻¹) module 175, an inverse DCT (DCT⁻¹) transform module 165, a subtractor 115, a summer 155, a deblocking module 151, and a reference buffer 150. Although the apparatus 100 comprises a plurality of modules, those skilled in the art will realize that the functions performed by the various modules are not required to be isolated into separate modules as shown in FIG. 1. For example, the set of modules comprising the temporal or spatial prediction module 140, inverse quantization module 175 and inverse DCT module 165 is generally known as an “embedded decoder”.

FIG. 1 illustrates an input video image (image sequence) on path 110 which is digitized and represented as a luminance and two color difference signals (Y, Cᵣ, C_{b}) in accordance with the MPEG standards. These signals can be further divided into a plurality of layers (sequence, group of pictures, picture, slice and blocks) such that each picture (frame) is represented by a plurality of blocks having different sizes. The division of a picture into block units improves the ability to discern changes between two successive pictures and improves image compression through the elimination of low amplitude transformed coefficients (discussed below). The digitized signal may optionally undergo preprocessing such as format conversion for selecting an appropriate window, resolution and input format.

The input video image on path 110 is received into temporal or spatial prediction module 140 for performing spatial prediction and for estimating motion vectors for temporal prediction. In one embodiment, the temporal or spatial prediction module 140 comprises a variable block motion estimation module and a motion compensation module. The motion vectors from the variable block motion estimation module are received by the motion compensation module for improving the efficiency of the prediction of sample values. Motion compensation involves a prediction that uses motion vectors to provide offsets into the past and/or future reference frames containing previously decoded sample values that are used to form the prediction error. Namely, the temporal or spatial prediction module 140 uses the previously decoded frame and the motion vectors to construct an estimate of the current frame.

The temporal or spatial prediction module 140 may also perform spatial prediction processing, e.g., directional spatial prediction (DSP). Directional spatial prediction can be implemented for intra coding, for extrapolating the edges of the previously-decoded parts of the current picture and applying it in regions of pictures that are intra coded. This improves the quality of the prediction signal, and also allows prediction from neighboring areas that were not coded using intra coding.

Furthermore, prior to performing motion compensation prediction for a given block, a coding mode must be selected. In the area of coding mode decision, MPEG provides a plurality of different coding modes. Generally, these coding modes are grouped into two broad classifications, inter mode coding and intra mode coding. Intra mode coding involves the coding of a block or picture that uses information only from that block or picture. Conversely, inter mode coding involves the coding of a block or picture that uses information both from itself and from blocks and pictures occurring at different times.

Once a coding mode is selected, temporal or spatial prediction module 140 generates a motion compensated prediction (predicted image) on path 152 of the contents of the block based on past and/or future reference pictures. This motion compensated prediction on path 152 is subtracted via subtractor 115 from the video image on path 110 in the current block to form an error signal or predictive residual signal on path 153. The formation of the predictive residual signal effectively removes redundant information in the input video image. Namely, instead of transmitting the actual video image via a transmission channel, only the information necessary to generate the predictions of the video image and the errors of these predictions are transmitted, thereby significantly reducing the amount of data needed to be transmitted. To further reduce the bit rate, predictive residual signal on path 153 is passed to the transform module 160 for encoding.

The transform module 160 then applies a DCT-based transform. Although the transform in H.264/MPEG-4 AVC is still DCT-based, there are some fundamental differences as compared to other existing video coding standards. First, transform is an integer transform, that is, all operations are carried out with integer arithmetic. Second, the inverse transform is fully specified. Hence, there is no mismatch between the encoder and the decoder. Third, transform is multiplication free, requiring only the addition and shift operations. Fourth, a scaling multiplication that is part of the complete transform is integrated into the quantizer, reducing the total number of multiplications.

Specifically, in H.264/MPEG4 AVC the transformation is applied to e.g., 4×4 blocks, where a separable integer transform is applied. An additional 2×2 transform is applied to the four DC coefficients of each chroma component.

The resulting transformed coefficients are received by quantization module 170 where the transform coefficients are quantized. H.264/MPEG-4 AVC uses scalar quantization. One of 52 quantizers or quantization parameters (QP)s is selected for each macroblock.

The resulting quantized transformed coefficients are then decoded in inverse quantization module 175 and inverse DCT module 165 to recover the reference frame(s) or picture(s) that will be stored in reference buffer 150. In H.264/MPEG-4 AVC an in-loop deblocking filter 151 is also employed to minimize blockiness.

The resulting quantized transformed coefficients from the quantization module 170 are also received by context-adaptive variable length coding module (CAVLC) module or context-adaptive binary arithmetic coding module (CABAC) 180 via signal connection 171, where the two-dimensional block of quantized coefficients is scanned using a particular scanning mode, e.g., a “zig-zag” order, to convert it into a one-dimensional string of quantized transformed coefficients. In CAVLC, VLC tables for various syntax elements are switched, depending on already-transmitted syntax elements. Since the VLC tables are designed to match the corresponding conditioned statistics, the entropy coding performance is improved in comparison to methods that just use one VLC table.

Alternatively, CABAC can be employed. CABAC achieves good compression by a) selecting probability models for each syntax element according to the element's context, b) adapting probability estimates based on local statistics and c) using arithmetic coding.

The data stream is received into a “First In-First Out” (FIFO) buffer 190. A consequence of using different picture types and variable length coding is that the overall bit rate into the FIFO is variable. Namely, the number of bits used to code each frame can be different. In applications that involve a fixed-rate channel, a FIFO buffer is used to match the encoder output to the channel for smoothing the bit rate. Thus, the output signal of FIFO buffer 190 is a compressed representation of the input video image 110, where it is sent to a storage medium or telecommunication channel on path 195.

The rate control module 130 serves to monitor and adjust the bit rate of the data stream entering the FIFO buffer 190 for preventing overflow and underflow on the decoder side (within a receiver or target storage device, not shown) after transmission of the data stream. A fixed-rate channel is assumed to put bits at a constant rate into an input buffer within the decoder. At regular intervals determined by the picture rate, the decoder instantaneously removes all the bits for the next picture from its input buffer. If there are too few bits in the input buffer, i.e., all the bits for the next picture have not been received, then the input buffer underflows resulting in an error. Similarly, if there are too many bits in the input buffer, i.e., the capacity of the input buffer is exceeded between picture starts, then the input buffer overflows resulting in an overflow error. Thus, it is the task of the rate control module 130 to monitor the status of buffer 190 to control the number of bits generated by the encoder, thereby preventing the overflow and underflow conditions. Rate control algorithms play an important role in affecting image quality and compression efficiency.

Before describing the present motion estimation method with weight prediction, a brief description of the AVC motion estimation method with weight prediction is provided. This will provide a reference point to measure the increased efficiency of the present motion estimation method.

AVC video coding standard allows three weight prediction modes in P and B slices: default, implicit and explicit modes. Default mode is identical to traditional video coding standard where the weight factor is equal to 1 when only one motion vector is used, and the weight factors are equal to ½ when two motion vectors are used. Implicit mode assigns the weight factors to the reference pictures according to their temporal distances from the current picture. Explicit mode uses the weight factors given by the user. In AVC, for a given sample pixel x(i, j) in the current block and a given reference picture of either List 0 and/or List 1 reference picture, the temporal prediction of the given pixel x(i, j) is determined as follows:

For forward prediction (predFlagL0=1 and predFlagL1=0),
\overline{x}(i,j)=[\overline{x}₀(i,j)×w₀] (2)

For backward prediction (predFlagL0=0 and predFlagL1=1),
\overline{x}(i,j)=[\overline{x}₁(i,j)×w₁] (3)

For bi-directional prediction (predFlagL0=1 and predFlagL1=1),
\overline{x}(i,j)=[(\overline{x}₀(i,j)×w₀+\overline{x}₁(i,j)×w₁)/2] (4)
where \overline{x}₀(i,j) and \overline{x}₁(i,j) are respectively the motion compensated sub-pel pixels of the List 0 reference picture and the List 1 reference picture at ¼ pel resolution, w₀ and w₁ are the weight factors for the List 0 reference picture and the List 1 reference picture, and [ ] is a rounding operation. The weighted predictions are subtracted from the original sample pixels of the current block, as shown in equation (5)
d(i,j)=x(i,j)−\overline{x}(i,j) (5)
where d(i, j) is the motion compensated difference for x(i, j). The motion compensated differences are encoded, thereby generating the compressed bitstream. The decoder uses identical weight factors to construct the weighted reference pictures in the process of decoding the compressed bitstream.

Motion estimation is a process that determines a temporal prediction block from the reference pictures for a given block in the current picture. The temporal prediction block can be one block or an average of two blocks from the reference pictures. In general, one of the criteria that is commonly used in determining the temporal prediction block for a given block is SAD, i.e., sum of absolute differences between two blocks, as defined as follows.
SAD=Σ|x(i,j)−\overline{x}(i,j)| (6)
where x(i, j) is a pixel and \overline{x}(i,j) is its prediction.

It should be noted there are other distortion measure calculations, such as mean absolute difference, median absolute difference and so on. There are at least two ways to implement SAD in motion estimation with weight prediction function. The straightforward method calculates the weighted prediction, x(i,j), for each pixel, x(i, j), of the current block in the current picture, on the fly, during the SAD calculation. That is, for forward prediction,
SAD=Σ|x(i,j)−[\overline{x}₀(i,j)×w₀]| (7)
and for backward prediction,
SAD=Σ|x(i,j)−[\overline{x}₁(i,j)×w₁]| (8)

Note that both \overline{x}₀(i, j) and \overline{x}₁(i, j) are at ¼ pel resolution. For bi-directional prediction, the temporal prediction block can be the average of the best selected forward and backward prediction blocks.
SAD=Σ|x(i,j)−[(\overline{x}₀(i,j)×w₀+\overline{x}₁(i,j)×w₁)/2]| (9)

As seen from equations (7) and (8), for calculating each difference between a sample pixel and its prediction at ¼ pel resolution, one extra multiplication and one extra rounding operation are required for forward or backward prediction. The overhead computations can be very costly in motion estimation process because the search windows of neighboring macroblocks are overlapped. This overlapping results in repetition of the same calculation of weighted pixel value. This repetition increases linearly with the size of search window just for the full pel search and the problem will only be exacerbated when it includes sub pel search.

Given a picture of (M×N) pixels and the motion search range of (m×n) pixels, the numbers of additional operations for motion estimation with weight prediction over N_{ref} reference pictures, as compared to motion estimation without weight prediction, are listed in Table 1. Note that each List 0 or List 1 reference picture may assign a separate weight factor, w₀ or w₁. Hence, N_{ref} reference pictures in List 0 or List 1 means N_{ref} unique weight factors, w₀ or w₁, and equations (7) and (8) therefore need to be implemented N_{ref} times, one for each reference picture. There is no requirement for extra memory for this straightforward method.

TABLE 1

| Prediction Direction | Multiplication | rounding |
|---|---|---|
| FW | N_{ref} × 4N × 4M × m × n | N_{ref} × 4N × 4M × m × n |
| BW | N_{ref} × 4N × 4M × m × n | N_{ref} × 4N × 4M × m × n |
| Bi-Directional | 2 × N × M | N × M |

The second method, then can be employed to calculate the weighted data before the SAD calculation. The numbers of additional operations as compared to motion estimation without weight prediction are now listed in Table 2.

TABLE 2

| Prediction Direction | Multiplication | Rounding |
|---|---|---|
| FW | N_{ref} × 4N × 4M | N_{ref} × 4N × 4M |
| BW | N_{ref} × 4N × 4M | N_{ref} × 4N × 4M |
| Bi-Directional | 2 × N × M | N × M |

During the SAD calculation, the encoder accesses the weighted reference picture buffer, and fetch the necessary data without performing any weighting calculation. The second method significantly reduces the number of real-time operations, as compared to the first method. However, the second method requires an extra amount of memory to hold the weighted reference pictures. The size of the additional memory is:
N_{ref}×4N×4M×2 (9)
where 2 is for two reference lists (List 0 and List 1). For interlace coding, the additional memory may be further doubled if the encoder maintains both reference frame buffer and reference field buffer. In that case, the reference pictures in the frame and field reference buffers are weighted differently.

The above two implementations suffer either from excessive memory requirement or excessive processing cycles. In contrast, the present invention utilizes an approximation of the weighting process in motion estimation to minimize both memory and computation problems.

Instead of the motion compensated sub-pel pixels of the reference pictures, the invention weights the original pixels of the current block in the SAD calculation. That is, for forward prediction:
SAD=Σ|\hat{x}(i,j)−\overline{x}₀(i,j)| (10)

where

$${x}^{⋒} ( i , j ) = \frac{1}{{w}_{0}} x ( i , j )$$

and for backward prediction:
SAD=Σ|\hat{x}(i,j)−\overline{x}₁(i,j)| (11)

where

$${x}^{⋒} ( i , j ) = \frac{1}{{w}_{1}} x ( i , j ) .$$

Note that the weight factors for the original pixels are simply the reciprocals of the weight factors assigned for the corresponding the reference pictures. In addition,

$${x}^{⋒} ( i , j ) = \frac{1}{{w}_{0}} x ( i , j )$$

and

$${x}^{⋒} ( i , j ) = \frac{1}{{w}_{1}} x ( i , j )$$

can be pre-calculated before the SAD calculation to avoid repetition of the same calculation of weighted pixel value during the SAD calculation. The numbers of additional operations, as compared to motion estimation without weight prediction, are listed in Table 3. As can be seen, the numbers in Table 3 are much smaller than in Tables 1 and 2.

TABLE 3

| Prediction Direction | Multiplication | Rounding |
|---|---|---|
| FW | N_{ref} × N × M | N_{ref} × N × M |
| BW | N_{ref} × N × M | N_{ref} × N × M |
| Bi-Directional | | |

In one embodiment, the pre-calculated data of

$${x}^{⋒} ( i , j ) = \frac{1}{{w}_{0}} x ( i , j )$$

and

$${x}^{⋒} ( i , j ) = \frac{1}{{w}_{1}} x ( i , j )$$

can be stored in a temporal memory. The stored data are fetched from the temporal memory during the SAD calculation. The additional memory for holding the necessary weighted data is only a block of a size that is smaller than or equal to 16×16 pixels, e.g., the same size as the current block. Alternatively, one can pre-store all the weighted pixels of the current picture per reference picture. The additional memory size will therefore be the same as the current picture size of (M×N) pixels. The first approach with the smaller memory requirement may be more desirable in some implementations.

Equations (10) and (11) may not be the same as (7) and (8) due the rounding operation. Namely, rounding may be optionally omitted. Hence, the present invention may give a slightly different motion estimation result than equations (7) and (8). However, the difference in motion estimation should be relatively trivial. In addition, since the invention is only implemented for motion estimation, it will not cause any mismatch with the decoder. Nevertheless, if rounding is desired, Table 3 shows that the present invention is still more efficient that previous motion estimation method with weight prediction.

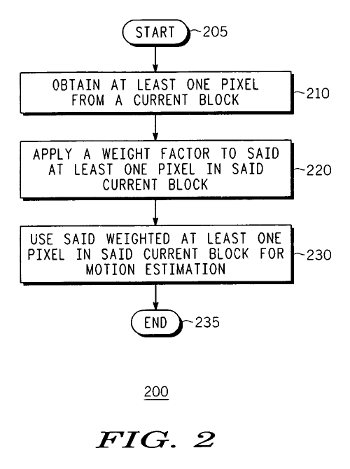

FIG. 2 illustrates a method 200 for performing motion estimation with weight prediction of the present invention. Method 200 starts in step 205 and proceeds to step 210.

In step 210, method 200 obtains at least one pixel from a current block. For example, in one embodiment, a block of pixels from a current block can be obtained.

In step 220, method 200 applies a weight factor to said at least one pixel in the current block. Thus, the weight factor is not applied to the reference picture or to the motion compensated sub-pixels of the reference picture.

In step 230, the weighted at least one pixel in the current block is used for motion estimation. Method ends in step 235.

FIG. 3 is a block diagram of the present encoding system being implemented with a general purpose computer. In one embodiment, the encoding system 300 is implemented using a general purpose computer or any other hardware equivalents. More specifically, the encoding system 300 comprises a processor (CPU) 310, a memory 320, e.g., random access memory (RAM) and/or read only memory (ROM), an encoder 322 employing the present motion estimation method, and various input/output devices 330 (e.g., storage devices, including but not limited to, a tape drive, a floppy drive, a hard disk drive or a compact disk drive, a receiver, a transmitter, a speaker, a display, an output port, a user input device (such as a keyboard, a keypad, a mouse, and the like), or a microphone for capturing speech commands).

It should be understood that the encoder 322 can be implemented as physical devices or subsystems that are coupled to the CPU 310 through a communication channel. Alternatively, the encoder 322 can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory 320 of the computer. As such, the encoder 322 (including associated data structures and methods employed within the encoder) of the present invention can be stored on a computer readable medium or carrier, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for performing motion estimation in an encoder for encoding an image sequence, comprising:
obtaining at least one pixel from a current block;
applying a weight factor to said at least one pixel from said current block; and
performing said motion estimation using said weighted at least one pixel from said current block.

2. The method of claim 1, wherein said encoder is a H.264/MPEG-4 AVC compliant encoder.

3. The method of claim 1, wherein said weighted at least one pixel from said current block is stored in a memory.

4. The method of claim 3, wherein said weighted at least one pixel comprises weighted pixels for said entire current block.

5. The method of claim 3, wherein said weighted at least one pixel comprises weighted pixels for an entire current picture.

6. The method of claim 1, where said weight factor is reciprocal to a weight factor assigned to an associated reference picture of said current block.

7. The method of claim 1, wherein said performing said motion estimation generates a motion vector for said current block.

8. The method of claim 7, wherein said performing implements a sum of absolute difference calculation, a mean absolute difference calculation, or a median absolute difference calculation.

9. A computer-readable carrier having stored thereon a plurality of instructions, the plurality of instructions including instructions which, when executed by a processor, cause the processor to perform the steps of a method for performing motion estimation in an encoder for encoding an image sequence, comprising of:
obtaining at least one pixel from a current block;
applying a weight factor to said at least one pixel from said current block; and
performing said motion estimation using said weighted at least one pixel from said current block.

10. The computer-readable carrier of claim 9, wherein said encoder is a H.264/MPEG4 AVC compliant encoder.

11. The computer-readable carrier of claim 9, wherein said weighted at least one pixel from said current block is stored in a memory.

12. The computer-readable carrier of claim 11, wherein said weighted at least one pixel comprises weighted pixels for said entire current block.

13. The computer-readable carrier of claim 11, wherein said weighted at least one pixel comprises weighted pixels for an entire current picture.

14. The computer-readable carrier of claim 9, where said weight factor is reciprocal to a weight factor assigned to an associated reference picture of said current block.

15. The computer-readable carrier of claim 9, wherein said performing said motion estimation generates a motion vector for said current block.

16. The computer-readable carrier of claim 15, wherein said performing implements a sum of absolute difference calculation, a mean absolute difference calculation, or a median absolute difference calculation.

17. An encoder for encoding an image sequence, comprising:
means for obtaining at least one pixel from a current block;
means for applying a weight factor to said at least one pixel from said current block; and
means for performing said motion estimation using said weighted at least one pixel from said current block.

18. The encoder of claim 17, wherein said encoder is a H.264/MPEG4 AVC compliant encoder.

19. The encoder of claim 17, wherein said weighted at least one pixel from said current block is stored in a memory.

20. The encoder of claim 17, where said weight factor is reciprocal to a weight factor assigned to an associated reference picture of said current block.
